(19) United States
(12) Patent Application Publication
(10) Pub. No.: US 2025/0390319 A1
(43) Pub. Date: Dec. 25, 2025

(54) APPARATUS, SYSTEM, AND METHOD FOR A COMMUNITY UX

(71) Applicant: SCOUT MOTORS INC., Tysons, VA (US)

(72) Inventors: Andre Nitze-Nelson, Tysons, VA (US); Matthew Metropulos, Tysons, VA (US); Jason Quint, Ann Arbor, MI (US); Eugene Kim, Tysons, VA (US); Amy Stoddard, Tysons, VA (US); André Orta, Tysons, VA (US)

(21) Appl. No.: 18/752,286

(22) Filed: Jun. 24, 2024

(51) Int. Cl. G06F 9/451; B60K 35/22; G01C 21/36; G06V 20/59

(52) U.S. Cl. CPC G06F 9/451; B60K 35/22; G01C 21/3667; G06V 20/593

(57) ABSTRACT

A method, apparatus, and computer program product are provided for a communal user experience for a user interface. Methods may include: providing for presentation on a user interface display of a user interface; providing for presentation of a user interface element proximate a first side of the user interface display, where the first side of the user interface display comprises a side closest to an operator of a vehicle associated with the user interface display; receiving an indication for the user interface element to be displayed proximate a second side of the user interface display, opposite the first side of the user interface display; and in response to the indication, providing for presentation of the user interface element proximate the second side of the user interface display.

### BACKGROUND

Vehicles have advanced significantly in recent years with the advent of new technologies, such as driver assistance technology that can at least semi-autonomously control the vehicle. Further, infotainment systems within cars are technologically advanced and provide features well beyond the radio of vehicles from years ago. The functionality of user interfaces of vehicles is ever-expanding with a wide array of applications and vehicle features that can be controlled via the user interface. The user interfaces of vehicles are generally driver-centric to facilitate driver, or in the case of a fully autonomous vehicle, operator, interaction. However, the driver/operator is often not the only person in a vehicle and other passengers may interact with the user interface of a vehicle.

### BRIEF SUMMARY

A user interface for a vehicle, and more particularly, a user interface configured to provide a communal user experience for a user interface is provided. Some embodiments include a vehicle including: a user interface display for displaying graphical user interfaces to occupants of the vehicle, where the user interface display is configured to: display a graphical user interface on the user interface display; display a user interface element proximate a first side of the user interface display, wherein the first side of the user interface display comprises a side closest to an operator of a vehicle associated with the user interface display; and a controller in communication with the at least one user interface display, where the controller is configured to: receive an indication for the user interface element to be displayed proximate a second side of the user interface display, opposite the first side of the user interface display, where the user interface display is further configured to, in response to the indication, display the user interface element proximate the second side of the user interface display.

According to some embodiments the indication for the user interface element to be displayed proximate the second side of the user interface display includes a detection of a presence of an occupant in a seat closest to the second side of the user interface display. According to certain embodiments the indication for the user interface element to be displayed proximate the second side of the user interface display includes a user input received at the user interface display. According to certain embodiments, the user interface display configured to display the user interface element proximate the second side of the user interface display is further configured to cease to display the user interface element proximate the first side of the user interface display. The indication for the user interface element to be displayed proximate the second side of the user interface display includes in some embodiments a determination of a presence of an occupant in a seat closest to the second side of the user interface display. According to some embodiments the determination of the presence of the occupant in the seat closest to the second side of the user interface display includes receiving a signal from at least one of a proximity sensor or a seat sensor identifying the presence of the occupant.

Some embodiments provide an apparatus including at least one processor and at least one non-transitory memory including computer program code instructions with the computer program code instructions being configured to, when executed, cause the apparatus to at least: provide for presentation on a user interface display of a graphical user interface; provide for presentation of a user interface element proximate a first side of the user interface display, where the first side of the user interface display comprises a side closest to an operator of a vehicle associated with the user interface display; receive an indication for the user interface element to be displayed proximate a second side of the user interface display, opposite the first side of the user interface display; and in response to the indication, provide for presentation of the user interface element proximate the second side of the user interface display.

According to some embodiments, the indication for the user interface element to be displayed proximate the second side of the user interface display includes a determination of a presence of an occupant in a seat closest to the second side of the user interface display. According to certain embodiments the indication includes a determination that the operator is unavailable to interact with the user interface element. The determination that the operator is unavailable includes, in some embodiments, a determination that attention of the operator is required for safe vehicle control.

According to certain embodiments, the determination that the attention of the operator is required for safe vehicle control includes a determination of an imminent maneuver of the vehicle requiring operator input. According to some embodiments, the indication for the user interface element to be displayed proximate the second side of the user interface display includes a user input received at the vehicle user interface display. The user input received at the user interface display includes, in some embodiments, an input received proximate the second side of the user interface display.

The user input received at the user interface display includes, in some embodiments, an input received proximate the first side of the user interface display of a motion toward the second side of the user interface display. According to certain embodiments, causing the apparatus to provide for presentation of the user interface element proximate the second side of the user interface display further includes causing the apparatus to provide for removal from presentation of the user interface element from proximate the first side of the user interface display.

Causing the apparatus of some embodiments to provide for removal from presentation of the user interface element from proximate the first side of the user interface display includes causing the apparatus to, through an animation on the user interface display, slide the user interface element off of the first side of the user interface display. According to some embodiments, causing the apparatus to provide for presentation of the user interface element proximate the second side of the user interface display includes causing the apparatus to, through an animation on the user interface display, slide the user interface element onto the second side of the user interface display.

According to some embodiments, the animation on the user interface display to slide the user interface element off the first side of the user interface display is synchronized with the animation on the user interface display to slide the user interface element onto the second side of the user interface display. According to certain embodiments, no part of the user interface element is provided for display on the user interface display at more than one location at the same time.

The graphical user interface presented on the user interface display includes, in some embodiments, a map interface comprising an icon representing a location of the vehicle on the map interface. Causing the apparatus of some embodiments to provide for presentation of the user interface element proximate the second side of the user interface display includes causing the apparatus to shift presentation of the map interface on the user interface display. According to certain embodiments, causing the apparatus to shift presentation of the map interface on the user interface display of the map interface includes causing the apparatus to retain the icon proximate a center of the map interface presented on the user interface display.

Some embodiments provided herein include a computer program product including at least one non-transitory computer-readable storage medium having computer-executable program code instructions stored therein, the computer-executable program code instructions comprising program code instructions to: provide for presentation on a user interface display of a graphical user interface; provide for presentation of a user interface element proximate a first side of the user interface display, where the first side of the user interface display comprises a side closest to an operator of a vehicle associated with the user interface display; receive an indication for the user interface element to be displayed proximate a second side of the user interface display, opposite the first side of the user interface display; and in response to the indication, provide for presentation of the user interface element proximate the second side of the user interface display.

According to some embodiments, the indication for the user interface element to be displayed proximate the second side of the user interface display includes a determination of a presence of an occupant in a seat closest to the second side of the user interface display.

Some embodiments provided herein include a method including: providing for presentation on a user interface display of a graphical user interface; providing for presentation of a user interface element proximate a first side of the user interface display, where the first side of the user interface display comprises a side closest to an operator of a vehicle associated with the user interface display; receiving an indication for the user interface element to be displayed proximate a second side of the user interface display, opposite the first side of the user interface display; and in response to the indication, providing for presentation of the user interface element proximate the second side of the user interface display. According to some embodiments, the indication for the user interface element to be displayed proximate the second side of the user interface display comprises a user input received at the user interface display.

### BRIEF DESCRIPTION OF THE DRAWINGS

Having thus described certain example embodiments of the present disclosure in general terms, reference will hereinafter be made to the accompanying drawings which are not necessarily drawn to scale, and wherein:

FIG. 1 illustrates a block diagram of a controller for controlling a user interface display according to some embodiments of the present disclosure;

FIG. 2 illustrates a user interface and user interface element presented on a user interface display according to some embodiments of the present disclosure;

FIG. 3 illustrates a user interface and two user interface elements presented on a user interface display according to some embodiments of the present disclosure;

FIG. 4 illustrates a user interface with a user interface element and a tab presented on a user interface display according to some embodiments of the present disclosure;

FIG. 5 illustrates another user interface with a user interface element and a tab presented on a user interface display according to some embodiments of the present disclosure;

FIG. 6 illustrates a user interface with a user interface element and a keyboard element presented on a user interface display according to some embodiments of the present disclosure;

FIG. 7 illustrates a user interface with a user interface element, a tab, and options presented on a user interface display according to some embodiments of the present disclosure;

FIG. 8 illustrates a user interface with a bottom menu bar user interface element and music player user interface element presented on a user interface display according to some embodiments of the present disclosure;

FIG. 9 illustrates a user interface with a bottom menu bar user interface element and an enlarged music player user interface element presented on a user interface display according to some embodiments of the present disclosure;

FIG. 10 illustrates another user interface with a bottom menu bar user interface element and an enlarged music player user interface element presented on a user interface display according to some embodiments of the present disclosure;

FIG. 11 illustrates a user interface with a user interface element and keyboard user interface element presented on a user interface display according to some embodiments of the present disclosure;

FIG. 12 illustrates a camera view user interface presented on a user interface display according to some embodiments of the present disclosure;

FIG. 13 illustrates another camera view user interface presented on a user interface display according to some embodiments of the present disclosure; and

FIG. 14 illustrates a flowchart of a process for controlling a user interface display according to some embodiments of the present disclosure.

### DETAILED DESCRIPTION

Some embodiments of the present disclosure will now be described more fully hereinafter with reference to the accompanying drawings, in which some, but not all, embodiments are shown. Indeed, various embodiments of the disclosure may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information,” and similar terms may be used interchangeably to refer to data capable of being transmitted, received and/or stored in accordance with some embodiments of the present disclosure. Thus, use of any such terms should not be taken to limit the spirit and scope of embodiments of the present disclosure.

As defined herein, a “computer-readable storage medium,” which refers to a physical storage medium (e.g., volatile or non-volatile memory device), is a non-transitory storage medium and may be differentiated from a “computer-readable transmission medium,” which refers to an electromagnetic signal.

Vehicles have become technologically advanced and have become considerably more than a mere means of conveyance. The operation of vehicles has similarly advanced with many vehicles employing some degree of autonomy, where vehicle systems control functions that historically required a human operator. The degree of autonomy can vary significantly among vehicles, ranging from minimal autonomy to complete vehicle autonomy that does not require a human driver. As autonomous vehicle functionality becomes more common, the control of a vehicle may be manual (without any autonomy), semi-autonomous (involving some autonomous features such as brake assist, cruise control, etc.), or fully autonomous (requiring little to no driver input). Thus, a “driver” in the conventional sense of the term may be only an occupant or user in a fully autonomous vehicle. The traditional role of a “driver” of a vehicle will herein be referred to as an “operator”, where a vehicle operator is a driver in a conventional vehicle with a lower level of autonomy, but where the operator may not perform any driving functions in a fully autonomous vehicle. The operator may perform any level of vehicle control interaction from complete control to mere observation and any degree of control in between.

The Society of Automotive Engineers (SAE) has adopted standard definitions of several levels of automation. Those levels range from SAE Level 0 to SAE level 5. SAE Level 0 requires a manual driver and has minimal assistance, such as automatic emergency braking, blind spot warning, and/or lane departure warnings. SAE Level 1 also requires a manual driver but may include features that provide steering or braking/acceleration support such as adaptive cruise control or lane centering technology. SAE Level 2 still requires a manual driver but can include features that provide steering and brake/acceleration support, such as lane centering and adaptive cruise control. SAE Levels 0-2 require constant driver supervision. SAE Levels 3-5 have autonomous features that do not necessitate constant driver supervision. In SAE Level 3, the driver is required to be present, but may not be required at all times. For SAE Levels 4 and 5, a driver is not required in most on-road conditions and areas. These various levels of autonomy are increasingly common though still heavily regulated.

A method, apparatus and computer program product are provided in accordance with an example embodiment of the present disclosure for a user interface for a vehicle, and more particularly, to a communal user experience for a user interface. Vehicle controls and user interfaces are generally driver-centric or operator-centric features that enable a vehicle operator to safely interact with the controls and user interface to perform various functions. While vehicle controls are typically operated by the vehicle operator, certain vehicle functions may be optionally interacted with by other occupants of the vehicle. Climate control functions, radio/audio functions, navigational operations may all be functions of a vehicle that can be operated by an occupant other than the operator.

A communal user experience does not focus on one particular user, but instead facilitates interaction by more than one user. Most graphical user interfaces are configured for single user interaction and maximizing the user experience for that single user. When multiple users interact with a graphical user interface, the interaction of a secondary user is often a less satisfactory experience than the primary user to whom the interface is focused. The communal user experience provided by some embodiments described herein enable a graphical user interface to have multiple users that can each have the impression that they are the focal user of the interface, improving the user experience for any user who interacts with the graphical user interface. Some embodiments described herein provide a user-centric and somewhat user-agnostic interface that adapts to the users of the interface in a manner that provides ease of operation and user satisfaction from the interface.

Historically, vehicle controls were minimal in number with most controls being manually operated and within reach of an operator without requiring substantial movement of the operator's body. As vehicles have developed and the capabilities of vehicles increased, the number and type of controls available within a vehicle has increased dramatically. Vehicles remain commonly operated by a single person, such that controls still remain operator focused with some controls accessible to other occupants. Controls that relate to non-essential vehicle control including radio, navigation, lighting, climate controls, certain vehicle settings, and other vehicle functionalities, collectively referred to as “infotainment”, may be vehicle functions that a non-operator of the vehicle may wish to interact with and control. Embodiments described herein provide a system and method through which the controls for various functionalities of a vehicle may be repositioned, duplicated/replicated, or otherwise modified dynamically within a vehicle to promote operation by a particular user or by plural users.

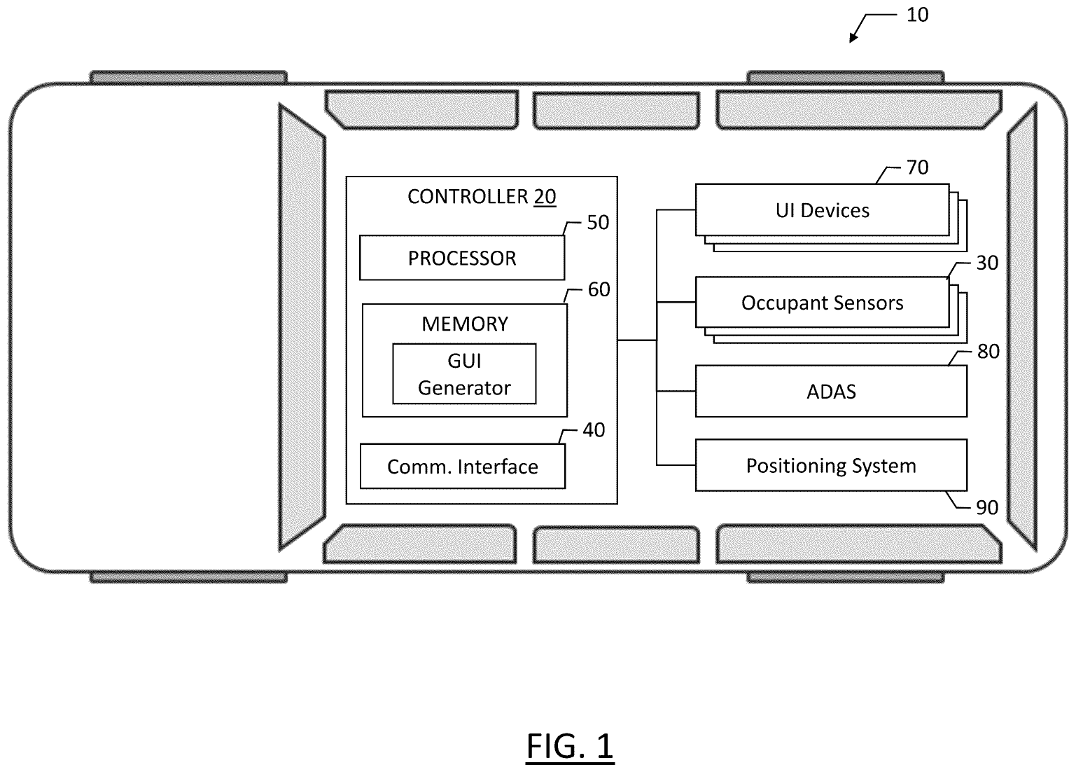

Embodiments described herein can be implemented in a variety of environments, such as a user interface display. The user interface display can be controlled, for example, using a controller where the controller may be embodied as a vehicle controller or a sub-unit controller of the vehicle, such as an infotainment system controller. FIG. 1 is a schematic diagram of an example embodiment of a vehicle 10 and a controller 20. The controller 20 of an example embodiment is integrated into the vehicle and connected to different elements described herein, such as through a wiring harness. The illustrated controller 20 can be embodied as any controller of the vehicle for controlling any features of the vehicle, with the depicted features of the illustrated embodiment being optional depending upon the application. For example, as mentioned above, the controller 20 can be embodied as an infotainment system controller; however, the present disclosure is not intended to be limiting in this regard. In other embodiments, the controller 20 could be a stand-alone controller or could be embodied via another vehicle controller, such as a vehicle control unit (VCU), an advanced driver assistance system (ADAS) controller, or the like.

The controller 20 of FIG. 1 can be configured to perform any of the operations described herein. Controller 20 is an example embodiment that may be embodied by or associated with any of a variety of computing devices that include or are otherwise associated with a vehicle. The controller 20 can be in communication with any systems, sensors, or other controllers of the vehicle 10, such as via a communications interface (e.g., a CAN bus). For example, the computing device may be an infotainment system of a vehicle, a navigation system, an autonomous vehicle controller, a vehicle control module, or the like. According to some embodiments, the controller 20 can include a computing device that provides instructions or commands to a vehicle control module or other vehicle controller, where the controller is a device in communication with various vehicle systems and control architectures. In this manner, some embodiments can be implemented on purely in-vehicle systems, through mobile devices commanding in-vehicle systems, or a combination thereof.

Optionally, the controller 20 may be embodied by or associated with a plurality of computing devices that are in communication with or otherwise networked with one another such that the various functions performed by the apparatus may be divided between the plurality of computing devices that operate in collaboration with one another.

The controller 20 may include, be associated with, or may otherwise be in communication with a communication interface 40, a processor 50, and a memory 60 The controller 20 may be in communication with one or more user interface devices 70, such as one or more displays that may include touch screen displays. In some embodiments, the processor 50 (and/or co-processors or any other processing circuitry assisting or otherwise associated with the processor) may be in communication with the memory 60 via a bus for passing information among components of the controller. The memory 60 may be non-transitory and may include, for example, one or more volatile and/or non-volatile memories. In other words, for example, the memory may be an electronic storage device (for example, a computer readable storage medium) comprising gates configured to store data (for example, bits) that may be retrievable by a machine (for example, a computing device like the processor). The memory 60 may be configured to store information, data, content, applications, instructions, or the like for enabling the apparatus to carry out various functions in accordance with an example embodiment of the present disclosure. For example, the memory 60 could be configured to buffer input data for processing by the processor. Additionally or alternatively, the memory 60 could be configured to store instructions for execution by the processor.

The processor 50 may be embodied in a number of different ways. For example, the processor 50 may be embodied as one or more of various hardware processing means such as a coprocessor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processor 50 may include one or more processing cores configured to perform independently. A multi-core processor may enable multiprocessing within a single physical package. Additionally or alternatively, the processor 50 may include multiple processors configured in tandem via the bus to enable independent execution of instructions, pipelining and/or multithreading.

In an example embodiment, the processor 50 may be configured to execute instructions stored in the memory 60 or otherwise accessible to the processor. Alternatively or additionally, the processor 50 may be configured to execute hard coded functionality. As such, whether configured by hardware or software methods, or by a combination thereof, the processor 50 may represent an entity (for example, physically embodied in circuitry) capable of performing operations according to an embodiment of the present disclosure while configured accordingly. Thus, for example, when the processor 50 is embodied as an ASIC, FPGA or the like, the processor 50 may be specifically configured hardware for conducting the operations described herein. Alternatively, as another example, when the processor 50 is embodied as an executor of software instructions, the instructions may specifically configure the processor 50 to perform the algorithms and/or operations described herein when the instructions are executed. However, in some cases, the processor 50 may be a processor of a specific device (for example, the computing device) configured to employ an embodiment of the present disclosure by further configuration of the processor by instructions for performing the algorithms and/or operations described herein.

As noted above, the controller 20 of an example embodiment may also include or otherwise be in communication with a user interface devices 70. The user interface devices 70 can include any feature of the vehicle 10 that a user interacts with including features such as climate control, infotainment interface, gauge cluster, etc. The user interface devices may include or otherwise be in communication with one or more displays, such as an infotainment system, a gauge cluster, an entertainment system (e.g., for rear seat passengers) or the like. The user interface devices 70 may optionally include one or more speakers, physical buttons, analog display (e.g., speedometer, fuel gauge, etc.) and/or other input/output mechanisms. The user interface devices 70 may be incorporated into the vehicle 10, such as a dedicated navigation system display/audio system or a device that can attach or associate with the vehicle via communication link. In an example embodiment, the processor 50 may include user interface circuitry configured to control at least some functions of one or more input/output mechanisms. The processor 50 and/or user interface circuitry comprising the processor may be configured to control one or more functions of one or more input/output mechanisms through computer program instructions (for example, software and/or firmware) stored on a memory accessible to the processor (for example, memory 60, and/or the like).

As shown, the vehicle 10 may be equipped with any number of occupant sensors 30. As described herein, an “occupant sensor” refers to any sensing device which can be used to detect the presence of one or more occupants in a cabin of the vehicle 10. Accordingly, the occupant sensors 30 can include, but are not limited to, pressure sensors embedded within seats in a vehicle, cameras, proximity sensors, infrared sensors, and so on. For example, the occupant sensors 30 may include pressure sensors within each seat of the vehicle 10 that are used to determine the presence of an occupant based on the occupant's weight in the seat and/or may include seatbelt sensors that detect when a seatbelt latch plate is inserted into a corresponding buckle (e.g., to determine whether the seatbelt is buckled). As another example, the occupant sensors 30 can include proximity sensors integrated into or otherwise positioned near a display device within the vehicle 10 (e.g., a central user interface device, as discussed below) that detect when a user's hand is in proximity to the display device, e.g., which can be used to infer that the user is about to interact with the display device.

It should be appreciated that the vehicle 10 may include a number of other sensors which may not be explicitly illustrated. For example, the vehicle 10 may include one or more of an accelerometer, a gyroscope, and a speed sensor (e.g., wheel speed sensors) to sense information regarding the movement, positioning, or orientation of the vehicle 10, e.g., for use in navigation assistance. In one such example, the vehicle 10 (or the controller 20 itself) could include an inertial measurement unit (IMU) that functions as an accelerometer and a gyroscope. The vehicle 10 may also include a light sensor, various image sensors (e.g., cameras), and more. As described in greater detail below, for example, the vehicle 10 may include various sensors and/or transceivers used for detecting a position, speed, etc. (e.g., for navigation) and/or for implementing various driving aids (e.g., parking sensors, radar for automatic cruise control and/or automated braking, cameras for lane center and object avoidance, etc.).

The controller 20 of an example embodiment may also optionally include a communication interface 40 that may be any means such as a device or circuitry embodied in either hardware or a combination of hardware and software that is configured to receive and/or transmit data from/to other electronic devices in communication with the controller 20. Additionally or alternatively, the communication interface 40 may be configured to communicate over any wired or wireless communication protocols. In some environments, the communication interface 40 may alternatively or additionally support vehicle to vehicle or vehicle to infrastructure wireless links.

The controller 20 of an example embodiment can be embodied by or otherwise in communication with various vehicle controllers such as a vehicle control unit, an ADAS, infotainment controller, or the like. These controllers can be separate or in a single module; however, these controllers function in concert to enable various aspects of vehicle functionality. As such, the controller 20 can be interpreted as a general controller performing each of these functions to enable vehicle functionality accordingly.

An ADAS 80 may be employed to perform various functions of a vehicle including control features that may be part of autonomous control of a vehicle, such as adaptive headlight aiming, adaptive cruise control, lane departure warning and control, curve warning, hazard warning, adaptive cruise control, among others. Other examples of an ADAS may include provisions for operating the vehicle in one or more of the various levels of SAE autonomous control detailed above.

An ADAS 80 and controller thereof may be used to provide various functionality of a vehicle and may be implemented to improve the comfort, efficiency, safety, and overall satisfaction of driving. Examples of such ADASs include semi-autonomous vehicle functions, such as adaptive cruise control, lane departure warning, speed limit notification, etc. Other examples of an ADAS 80 may include provisions for fully autonomous vehicle control without requiring input from a driver. Some of these advanced driver assistance systems use a variety of sensors in the vehicle to determine the current state of the vehicle and the current state of the roadway ahead of the vehicle. These sensors may include radar, infrared, ultrasonic, and vision-oriented sensors such as image sensors and light distancing and ranging (LiDAR) sensors.

The vehicle 10 can optionally include a positioning system 90 which may be in communication with controller 20 as shown in FIG. 1. The positioning system can include any type of Global Navigation Satellite Systems (GNSS) such as the Global Positioning System (GPS), BeiDou Navigation Satellite System (BDS) positioning system, Galileo positioning system, or any other standardized positioning system. The positioning system 90 can optionally include systems that are not satellite-based, but use other methods of localization, such as wireless access point triangulation or the like. The positioning system 90 can be used in conjunction with the ADAS 80 or user interface devices 70 such as a navigation system, for example.

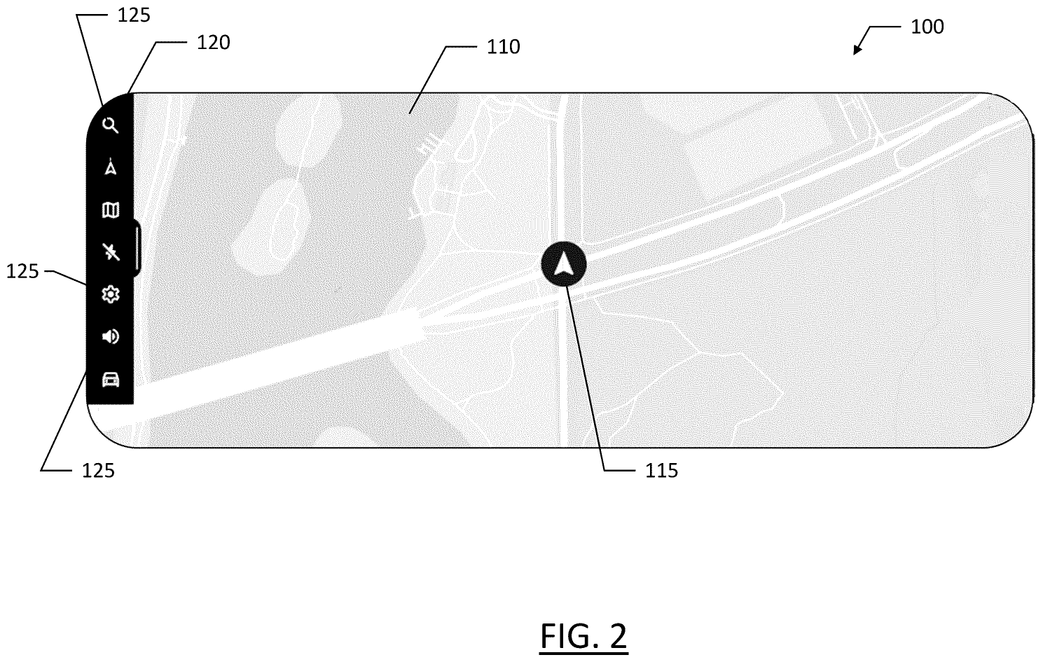

FIGS. 2-13 illustrate graphical user interfaces that include user interface elements that may receive input from a user. The graphical user interfaces of the example embodiments may be presented, for example, on a display device of vehicle 10. The display device may be, for example, a user interface device 70 and the graphical user interfaces may be provided for display, such as by controller 20.

FIG. 2 illustrates an example embodiment of a graphical user interface 100 of an infotainment system of a vehicle for presentation on a display. The illustrated graphical user interface may be any shape or size and may be presented on a display positioned in a variety of locations within a vehicle while adhering to embodiments of the present disclosure. The shape and size of the graphical user interface 100 shown in FIG. 2 is merely an example of such an interface that may be presented on a graphical user interface. The graphical user interface may be presented on a display screen and may be a touchscreen user interface, such as user interface device 70 of FIG. 2 for the infotainment system of a vehicle, whereby a user can touch elements on the screen to perform certain actions. The term “infotainment system” as described herein generally describes one or more systems of the vehicle that provides information, entertainment, and control of various features, systems, and functions of the vehicle. Further, multiple displays or user interfaces may be provided for different functions of a vehicle whereby certain functions may be controlled by one or multiple user interfaces. An example may include a climate control system that can be operated through an infotainment screen (e.g., display screen) and/or through tactile switches, buttons, or dials for example.

Optionally, there may be multiple user interfaces employing display screens such that some or all functions of the infotainment system can be controlled through multiple display screens. An example of which may include a sound system of a vehicle that can be operated through a user interface display operable by front seat occupants/operators, while another user interface display may be operable by occupants of the vehicle in a row of the vehicle other than the front seat row. The “user” as described herein can be an operator of the vehicle or another occupant who interfaces with a user interface.

The illustrated embodiment described herein can include a graphical user interface displayed on a display screen otherwise referred to as a graphical user interface 100 that is positioned forward of and between an operator seat and another front occupant seat, such as proximate the dashboard where a conventional radio or navigational screen may be positioned. The display need not be centered between the front seats of the vehicle but can be operator-biased in location or in some cases passenger biased.

As shown in FIG. 2, the graphical user interface 100 includes display of an image which in the illustrated embodiment is a depiction of a map interface 110 and includes an icon 115 at a projected location of the vehicle within the mapped region. The illustrated embodiment is depicted as a graphical user interface 100 presented on a display screen of a “left-hand drive” vehicle, conventional in the United States where an operator is seated in a front, left seat of the vehicle. A user interface menu bar 120 is depicted on the left side of the graphical user interface 100, closest to an operator position of the vehicle. This menu bar 120 is arranged on the left side of the graphical user interface 100 to be more easily operable and reachable by an operator of the vehicle. However, when the vehicle is occupied by more than one person, such as an operator and an occupant in a front right seat or “passenger seat”, the occupant may wish to interact with the graphical user interface 100. In such a scenario, the menu bar 120 of the graphical user interface 100 may require the occupant to move more than just their arm and hand to reach the menu bar, which may be cumbersome, uncomfortable, and potentially unsafe depending upon a relative position between the occupant reaching for the menu bar 120 and a seatbelt or airbag associated with the occupant's seat. The menu bar 120 for the illustrated map interface 110 includes menu buttons 125 for functions such as searching within the map interface (e.g., for a destination or point of interest), settings, volume, etc.

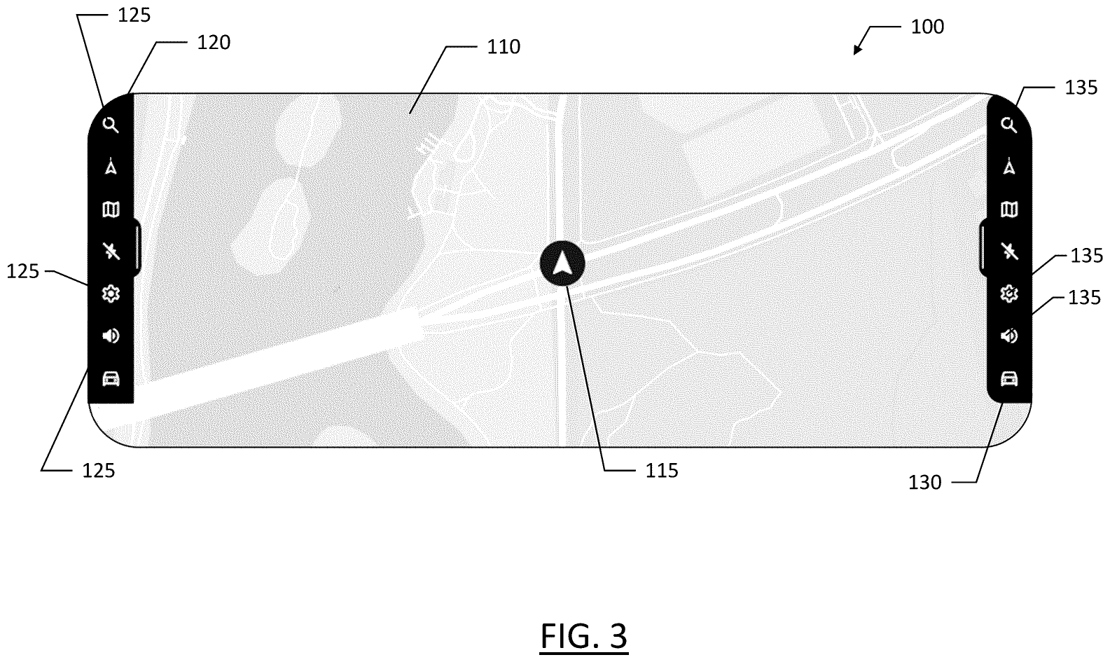

Embodiments described herein provide a method and system by which the occupant can more readily interface with a graphical user interface of the vehicle by providing alternate or additional positioning of controls for the graphical user interface and repositionable elements of the graphical user interface. FIG. 3 illustrates a first example embodiment of the graphical user interface 100 of FIG. 2 including the map interface 110, icon 115, and the menu bar 120. Further depicted in FIG. 3 is a second menu bar 130 that includes menu buttons 135 that duplicate the menu buttons 125 of the first menu bar 120. This second menu bar 130 is positioned closer to the occupant's seat and is thus more easily reached by the occupant should they wish to interact with the map interface 110.

Display screen sizes in vehicles are often value-added features for a vehicle such that occupying portions of the display with superfluous controls such as duplicate menu bars may be undesirable, particularly for display screens that may have limited display space or may be displaying multiple windows for different functionalities. Further, multiple instances of a single menu button may introduce issues for the underlying functionality in terms of which menu button to prioritize should more than one be pressed simultaneously. As such, in some embodiments rather than duplicating a menu bar, a menu bar may be repositioned for convenience of the occupant who intends to be a user of the user interface. In such an embodiment is may be desirable to have functionality of the display screen and graphical user interface 100 that can determine how and when to display alternative or additional user interface controls.

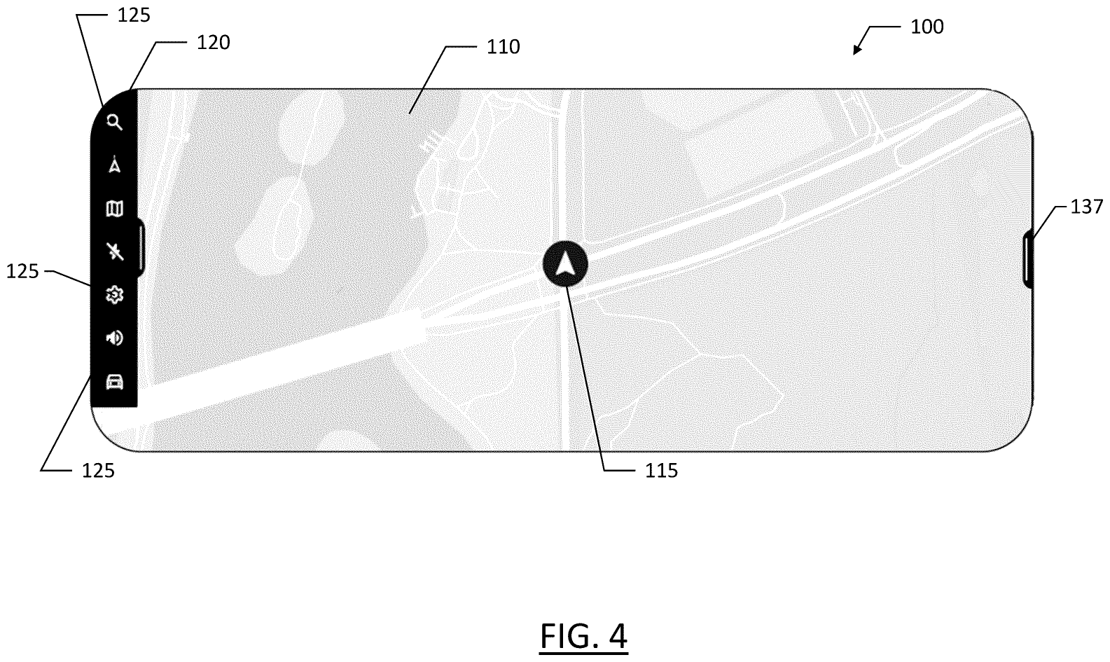

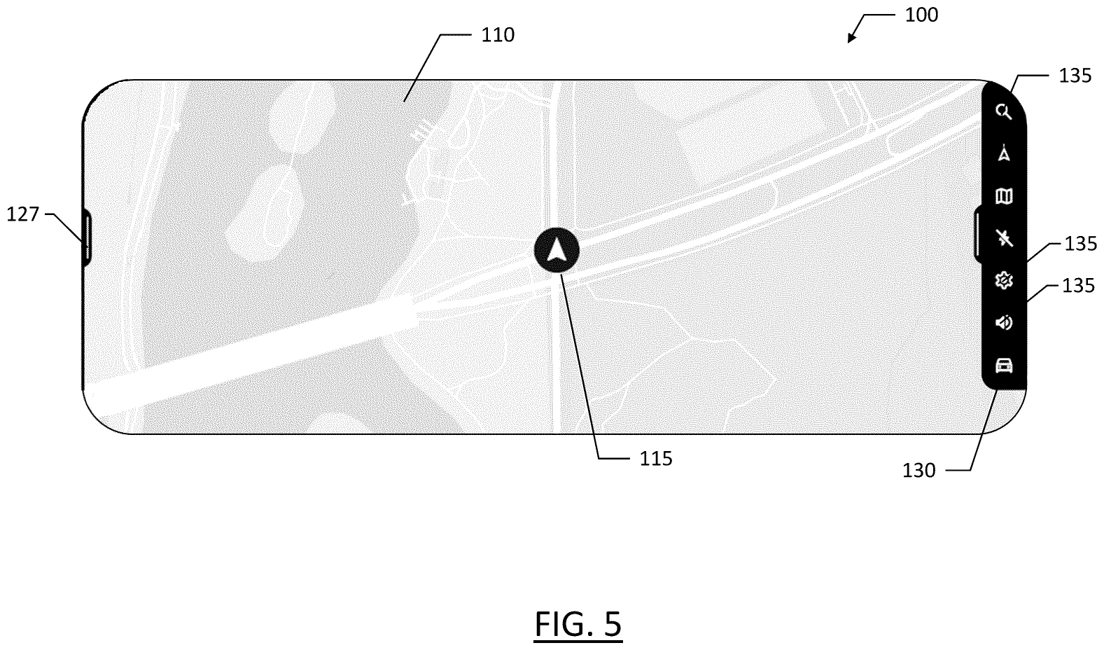

FIG. 4 illustrates an example embodiment of the graphical user interface 100 with the image of the map interface 110 with the first menu bar 120 displayed on a left side of the graphical user interface 100. The first menu bar 120 includes a first tab 127. While the second menu bar (e.g., the second menu bar 130) is not displayed, visible is a second tab 137. The second menu bar may be displayed responsive to a user interaction with the second tab 137, such as to touch and draw the second tab 137 away from the right edge of the display to expose the second menu bar. As occupying the display with both menu bars may be undesirable in some instances, FIG. 5 illustrates a result of the interaction to display the second menu bar 130 at the right side of the graphical user interface 100, where the first menu bar has become hidden and only the first tab 127 is illustrated. In this way, the controls appear to “wrap around” a back of the display screen such that when one is moved onto the graphical user interface 100 of the display screen, the other is drawn off of the display screen as if they are connected around a back side of the display screen.

While the first tab 127 and second tab 137 are described above as user interface elements to select which controls to display and where to display them in the aforementioned embodiment, systems and methods described herein can include alternative techniques of presenting controls proximate one user while possibly hiding the controls proximate another user. For example, the graphical user interface 100 of example embodiments may include therein, such as present in a border or outer edge of the display screen, one or more proximity sensors (e.g., occupant sensors 30 of FIG. 1). Such proximity sensors may be configured to detect a user's hand approaching the display. If a hand is approaching from a right side of the display, controls may be displayed on the right side of the display, such as the second menu bar 130. If a hand is approaching from a left side of the display, controls may be displayed on the left side of the display such as the first menu bar 120.

Determining an imminent user interaction can be performed, such as by controller 20, using one or more sensors. As noted above, a proximity sensor may be able to detect a person's hand approaching the display. An image sensor or camera can optionally be used to determine the presence of a user's hand approaching the screen or to detect a gesture of a user to determine which vehicle occupant is planning to interact with the display. The sensor(s) can also be used to determine the absence of a user's hand and use such detection to remove a user interface element from a display. Such a feature may be desirable to minimize elements on the display that are not being used imminently to make more display space available.

The presence of occupants within the vehicle can optionally be used to enable different control strategies. Sensors, such as occupant sensors 30 of FIG. 1, as described above, can include seat sensors that detect the presence of a person within a seat can identify where occupants are sitting in a vehicle and can provide user interaction according to the presence of occupants within the vehicle. Seat sensors can include a weight sensor or pressure sensor to determine the presence of an occupant (e.g., relative to an object that is likely to weigh less than an occupant). For example, each seat in vehicle 10 (not shown) may include an integrated weight or pressure sensor for detecting when the seat is occupied by a person.

Optionally, the presence of an occupant can be determined based on other occupancy sensors 30 including but not limited to proximity sensors, image sensors, or the like which may be associated with the graphical user interface or employed for other features of a vehicle. The sensors can be seat mounted, dashboard mounted, within the graphical user interface (e.g., in a bezel of a display), in a headrest, headliner, visor, etc. For example, vehicle 10 could include one or more occupant-facing cameras such that images captured by the occupant-facing camera(s) can be analyzed (e.g., using computer vision techniques) to determine a number and/or position of occupants within a cabin of vehicle 10. The widespread implementation of various sensors within a vehicle is ever-increasing such that a sensor used for other purposes (e.g., determination of whether an airbag for a seating position should be on or off) can be employed to determine the presence or absence of an occupant.

Optionally, a seat belt sensor can be used to not only determine a presence of an occupant, but to require the seat belt to be engaged when an occupant is present in order to interact with the user interface. For example, similar to the weight and/or pressure sensors mentioned above, each seat and/or corresponding seatbelt mechanism in vehicle 10 may include a sensor (e.g., a microswitch) to detect when a seatbelt latch is full inserted into a corresponding seatbelt buckle. In this regard, it can be inferred (e.g., by controller 20) that a person is occupying a corresponding seat if the seatbelt sensor indicates that the latch is inserted into the buckle. Further, sensors for weight and/or pressure in each seat may be utilized in combination with seatbelt sensors to detect occupants, e.g., to minimize so-called “false positives” from a seatbelt being latched without an occupant in the seat. Such presence detection can optionally be used to avoid presenting superfluous user controls or interface elements. For example, the second tab 137 shown in the graphical user interface 100 of FIG. 4 may not be displayed if a person is not determined to be present in a front, right seat of the vehicle.

According to some embodiments, in addition to presence sensing of an occupant, an attention determination can be made based on one or more sensors of the vehicle. An occupant that is present may not be available for interaction with the graphical user interface. An occupant-monitoring sensor such as a camera may determine if the occupant is attentive or not. An occupant may be sleeping, reading, or otherwise occupied and a sensor may determine whether the occupant is available for user input or not. If the occupant is determined to not be available for user input, some embodiments may function as if the occupant is not present and direct user interface elements toward an operator of the vehicle. Occupant attention can be established using a sensor, such as an occupant sensor 30, which may include a camera used for tracking the eye movement and direction of focus of an occupant. Such a sensor could determine when an operator is paying attention or available to interact with a graphical user interface display.

Embodiments provided herein can further provide user interface elements available only to a non-operator of a vehicle when the operator attention is required for safe operation of the vehicle (e.g., when not in substantially fully autonomous control). A determination as to when the operator's attention is required can be established, for example, by the level of autonomous operation of the vehicle, environmental issues, detected hazards, or other sensors of a highly automated vehicle that may rely on an operator for ultimate control of the vehicle. For example, if a front right occupant is present in the vehicle (if the system is so configured to determine), user interface elements may be available to the occupant while operator attention is required to control the vehicle. One such user interface element is a keyboard provided for display on a graphical user interface of a display screen.

Determining whether an operator's attention is required and the level of attention required is not a trivial matter. For vehicles with full autonomy that are able to drive themselves without operator intervention, operator attention may be seldom required. However, depending on the degree of autonomy, operator attention can be necessary for a variety of situations. For example, traffic situations, navigational requirements, unexpected road conditions, and the like are situations where vehicle autonomy may require supervision or an operator may be needed to control the operation of the vehicle. Traffic situations can include scenarios such as lane speed differential, such as when adjacent lanes have significant speed differentials (e.g., more than 20 miles per hour). Such a situation can lead to a very slow vehicle moving into the faster lane and becoming an obstacle. Traffic situations can also include where there is heavy traffic and poor visibility, or emergency vehicle presence. Navigational requirements can include a variety of scenarios such as the lanes of a road or the road itself not matching an anticipated or previously mapped area or possibly not present on a map (e.g., a driveway, unpaved path, new road pattern, etc.). Navigational scenarios in which an operator's attention may be required can also include situations where a maneuver is required, but the maneuver is challenging or requires decisions based on current circumstances. Road conditions can include scenarios such as where weather conditions preclude certain autonomous control features, unanticipated obstacles or objects, lane line absence, or construction situations, for example.

The determination of whether an operator's attention is necessary and the degree to which it is necessary can be made, for example, using an advanced driver assistance system (ADAS) described in greater detail below. The determination regarding operator attention level necessary can be a static determination, such as within a particular geographic location a certain level of attention is required, or dynamic where the conditions of the environment (e.g., weather, traffic, etc.) are used to help establish the level of attention required. The specific level of attention required may differ based on the capabilities of a vehicle, such that the determination may be vehicle specific. The location and environment considerations can be processed, such as by an ADAS or other computing system, to establish what aspects of vehicle operation can be controlled autonomously versus what aspects of vehicle operation require a human operator or supervision.

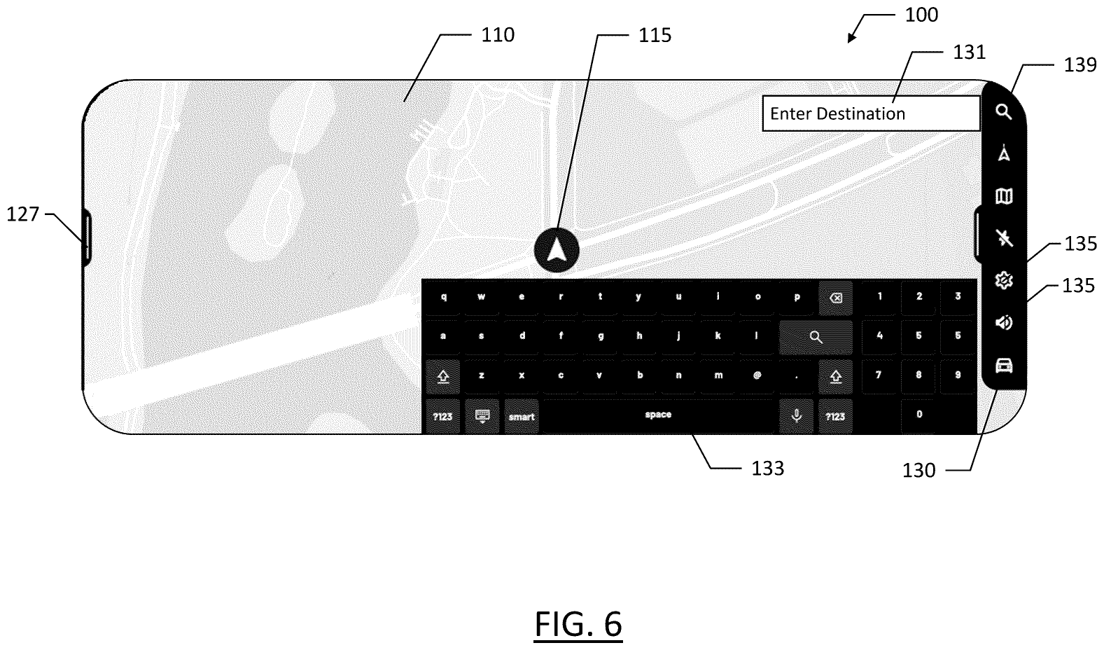

FIG. 6 illustrates an example embodiment of such an embodiment where an operator of the vehicle's attention is required for vehicle control. As shown, the graphical user interface 100 includes a user interface element of a “search” user interface element 139 that has been selected bringing up a text box 131 in which a destination is to be entered. As this search has been selected through the second menu bar 130, a keyboard 133 is presented intended for the use of the occupant of the front right seat of the vehicle. The keyboard is biased toward the occupant's side of the vehicle to both discourage use by an operator and to make interaction by the occupant more accessible. A non-operator occupant can thus focus on the keyboard and type in a desired destination for the navigation system.

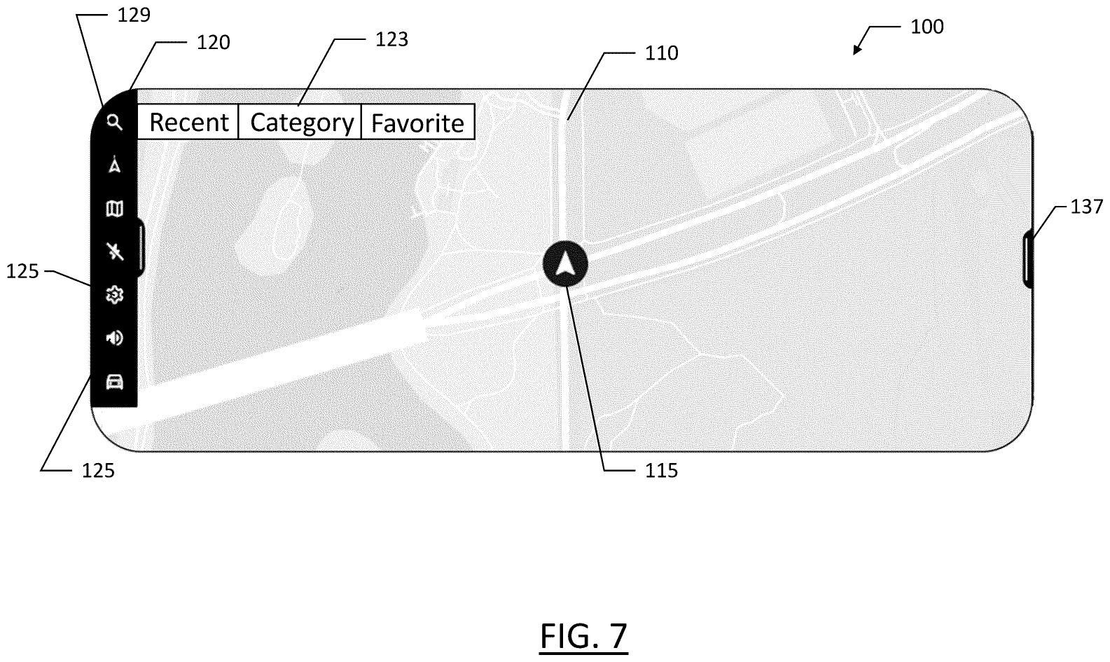

FIG. 7 illustrates the graphical user interface 100 with presentation of the “search” user interface element 129 of the first menu bar 120 on an operator's side of the graphical user interface 100 selected while the operator's attention is needed for safe operation of the vehicle. Instead of providing for display of a text box and keyboard as done in response to actuation of the search user interface element 129 of the occupant side of the display, a short list of options is presented that an operator can interact with while maintaining focus on control of the vehicle. The illustrated options 123 include “recent” for recently selected destinations, “category” for bringing up categories of points of interest, and “favorite” for bringing up predefined favorite destinations such as a place of work or a home location. Thus, the available interaction options can differ depending on both the intended user of the presented user interface elements and a status of the vehicle as to whether the operator's attention is required for safe operation. If the vehicle is operating in fully-autonomous mode, not moving, or an operator's attention is not required for safe operation, selection of the search user interface element 129 on the left side of the graphical user interface 100 may cause a text box and keyboard to appear, as seen in FIG. 6, though proximate the left side of the graphical user interface 100 in a manner more accessible to an operator of the vehicle as they can safely direct their attention to entering destination information via keyboard.

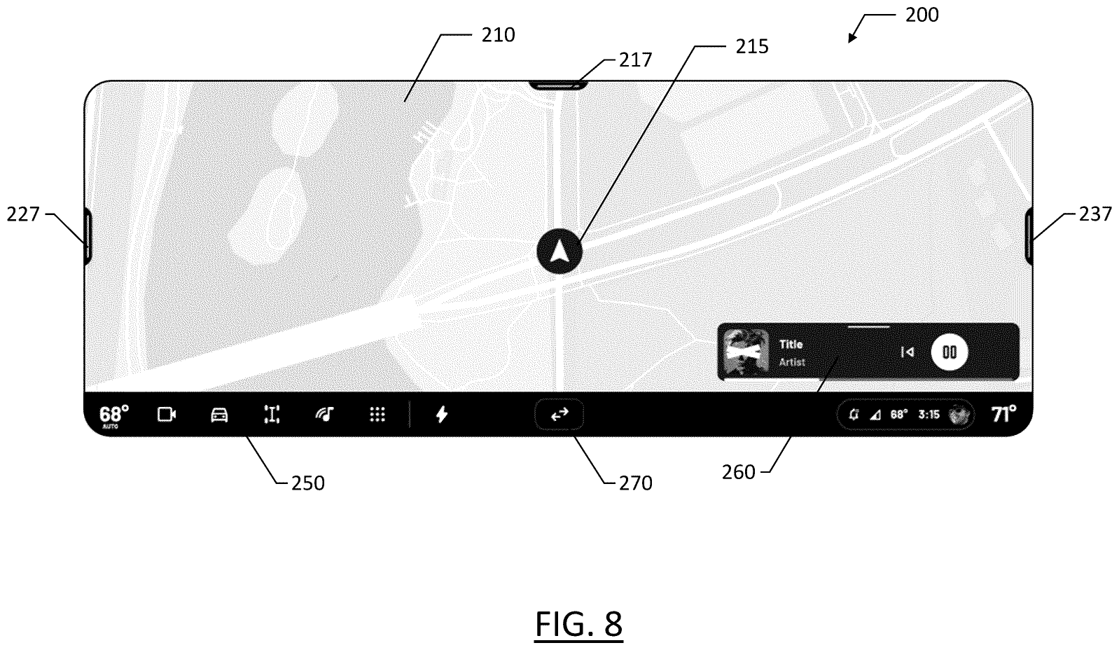

Embodiments described herein can provide alternative methods to interact with a graphical user interface 100 of a vehicle as described further below. FIG. 8 illustrates another graphical user interface 200 depicting an image also in the form of a map interface 210 with an icon 215 depicting the vehicle location and including a top tab 217, a left tab 227, and right tab 237. The graphical user interface 200 also features a bottom menu bar 250 with user interface elements that provide access to different functionalities and settings of the vehicle. Also shown on the graphical user interface 200 of FIG. 8 is a music player user interface element 260 that includes information regarding the track that is playing in addition to controls that can play, pause, fast forward, and rewind the track. The music player user interface element 260 is displayed proximate a bottom right of the graphical user interface 200 in a minimized form factor where a small icon and title of the track are displayed along with essential controls for the music player.

The position of the music player user interface element 260 can be moved based on the desires or needs of the operator or occupant of the vehicle. For example, if an occupant is present but unable to interact with the music player interface element (e.g., if they are otherwise occupied or disinterested), the interface element can be moved proximate a left side of the graphical user interface on the display screen.

Optionally, if the graphical user interface 200 is displaying something of interest behind the music player user interface element 260, it may be desirable to move the interface element to an upper corner of the graphical user interface. Movement of the music player user interface element 260 can be accomplished by a number of methods. For example, a user can “drag and drop” the user interface element on the display. Optionally, the menu bar may include a “swap sides” button 270 as shown in FIG. 8. This button may cause user interface elements to be presented on the graphical user interface 200 or a subset thereof to swap sides.

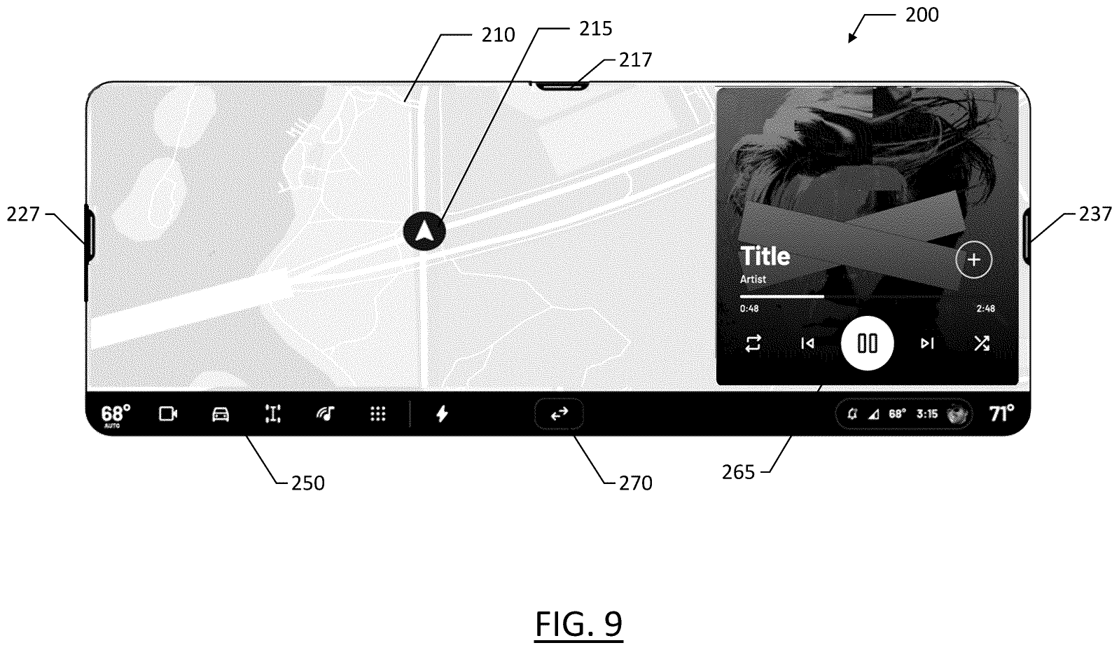

According to embodiments described herein, the user interface elements may have more than one native size for operation. As noted above, the music player user interface 260 of FIG. 8 is displayed in a minimized form factor which can provide a greater view of the image of the map interface 210 or alternatively provide more space on the graphical user interface 200 for other user interface elements to be displayed. The music player user interface element 260 of an example embodiment is expandable to a larger form factor where more information may be displayed about the music player and/or the track information played. FIG. 9 illustrates such an embodiment in which the music player user interface element 265 has been expanded to a larger size providing greater space for title information to be displayed and any album art that may be relevant. This expansion may be performed through a user interaction with the music player user interface element 260 of FIG. 8, such as by a dragging-up motion proximate a top of the user interface element. This motion may cause the user interface element to expand to a size corresponding to the dragging motion or to a predetermined larger size as illustrated in FIG. 9.

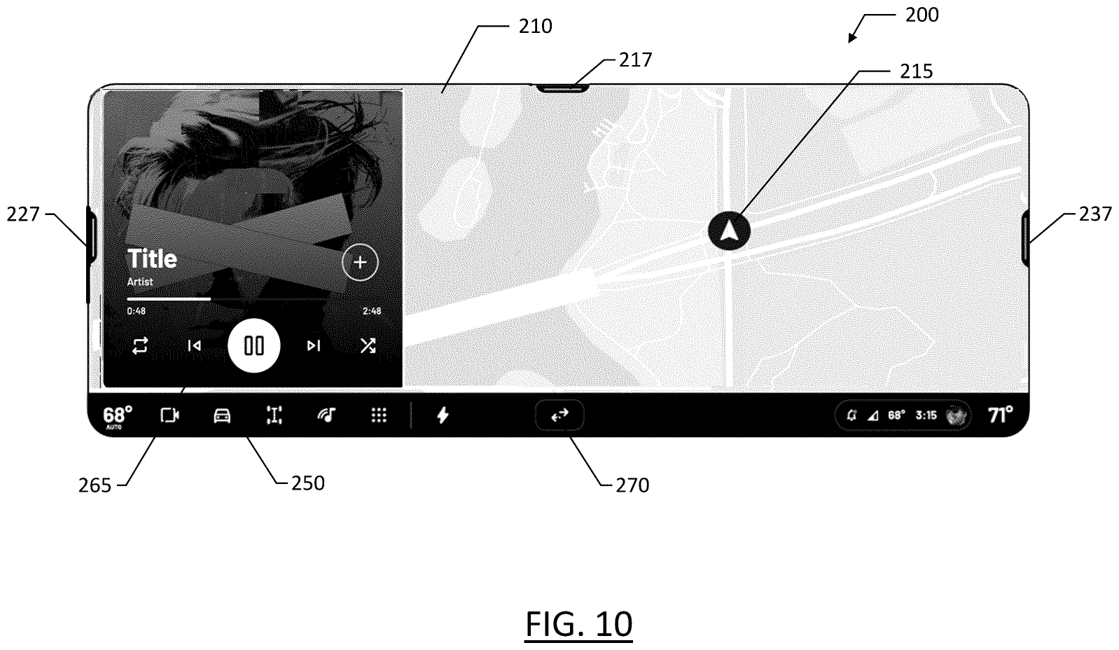

FIG. 10 illustrates the “swap sides” operation performed based, for example, on the “swap sides” button 270 where the music player user interface element 265 has swapped from proximate the right side of the graphical user interface 200 to the left side. Also depicted in both FIGS. 9 and 10 is the repositioning of a central location of the icon 215 reflecting the current position of the vehicle on the image of the map interface 210. In FIGS. 9 and 10, responsive to the music player user interface element 265 expanding to cover a substantial portion of the image of the map interface 210, the map is repositioned to center the icon 215 such that it remains proximate a center of the displayed area of the image of the map interface 210. This provides a consistent visual effect for a user to more readily be able to identify a position of the vehicle on the map and to be able to anticipate where they will find the icon when viewing the map interface 210.

According to some embodiments, the swapping of sides of a user interface element may not be performed by a user but based on conditions of the vehicle or occupants. For example, an operator and an occupant may be on a drive where the operator does not require complete, undivided attention on the task of driving, such that the operator is interacting with a user interface element (e.g., the music player user interface element 265) that is situated proximate a left side of the graphical user interface 200. The vehicle may be approaching some maneuver, road condition, road obstruction, or other situation that requires complete operator attention. This determination may be made, for example, by an ADAS that identifies the maneuver/condition/situation. Upon determining that the operator's attention is necessitated, the user interface element that the operator is interacting with may either switch automatically to proximate a right side of the graphical user interface 200 for an occupant to interact with, or a warning/suggestion may be presented on the graphical user interface 200 to provide the option for the user interface element to be switched to become occupant focused due to the upcoming maneuver/condition/situation.

According to some embodiments it can be determined whether an operator is provided an option or if the user interface element is moved from operator focused (e.g., left side of the graphical user interface) to occupant focused (e.g., right side of the graphical user interface). In an instance where an operator's attention is necessary for control of some function of the vehicle (e.g., steering), the user interface element may automatically switch to become occupant focused. If the operator's attention is not needed immediately, or if the full attention of the operator is not necessary, the operator may be provided with an option/recommendation to reposition the user interface element.

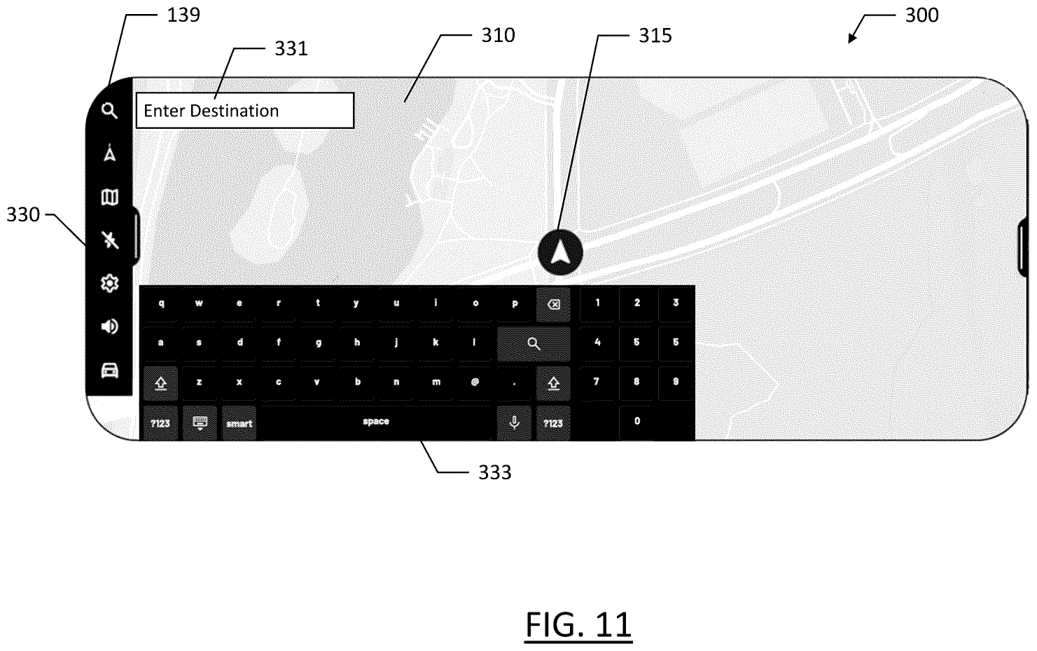

In some instances, such as when a vehicle is driving in a substantially autonomous vehicle mode, such as SAE Level 3 autonomy, an operator may be presented with a keyboard proximate the operator's side of the graphical user interface. FIG. 11 illustrates such an embodiment where an image of a map interface 310 is presented in graphical user interface 300 with icon 315 depicting the vehicle location on the map interface. In the illustrated embodiment, the search user interface element 339 has been selected from the menu bar 330 to present text box 331 and keyboard 333. If the vehicle was operating in SAE Level 3 and autonomy was ceded to the operator based on the current conditions of the vehicle, the operator may only be presented with the options as shown in FIG. 7. However, during autonomous control of SAE Level 3, the operator may be presented with the keyboard 333. The operator can begin to enter a destination into the textbox 331 using the keyboard 333. During selection of the destination, if autonomous vehicle control is being ceded to the operator, the operator may be presented with an option to allow an occupant (if present) to continue the destination search. Upon the operator accepting the option, the keyboard and text box may be moved to become occupant focused as illustrated in FIG. 6, where the occupant may continue what the operator had started.

The embodiments of FIGS. 2-11 illustrate graphical user interfaces with an underlying map interface displayed across the graphical user interface, under certain user interface elements and somewhat shifted by other user interface elements. The map interface is a desirable interface to have present much of the time such that employing the map interface as the predominant interface provides a useful foundation over which other user interface elements are positioned, manipulated, and repositioned. The map interface of the aforementioned embodiments is also readily re-centered, zoomed, and otherwise translatable on the display to be a graphical user interface that is useful and informative, while providing navigation information to a user. According to embodiments described herein, there are other interface elements that can supersede a map interface in being presented across a graphical user interface to benefit an operator and/or occupant of a vehicle.

The safety of vehicle operation is paramount in operation of all systems, and the use of camera views of the immediate vicinity of the vehicle is a beneficial safety feature that enables an operator to safely maneuver a vehicle within an environment. When a vehicle is commanded to be in a reversing gear or mode, a rear-view camera may be displayed across the graphical user interface regardless of the user interface elements previously displayed. Further, when a vehicle is maneuvering at slower speeds in crowded environments, such as parking lots, various camera views can help an operator safely navigate among the obstacles of the environment. Still further, when a vehicle is traversing an off-road environment, the non-uniformity of the areas around each wheel can be challenging to navigate. As such, embodiments described herein employ a camera interface that enables users to view a variety of camera views to maintain safe travel within an environment.

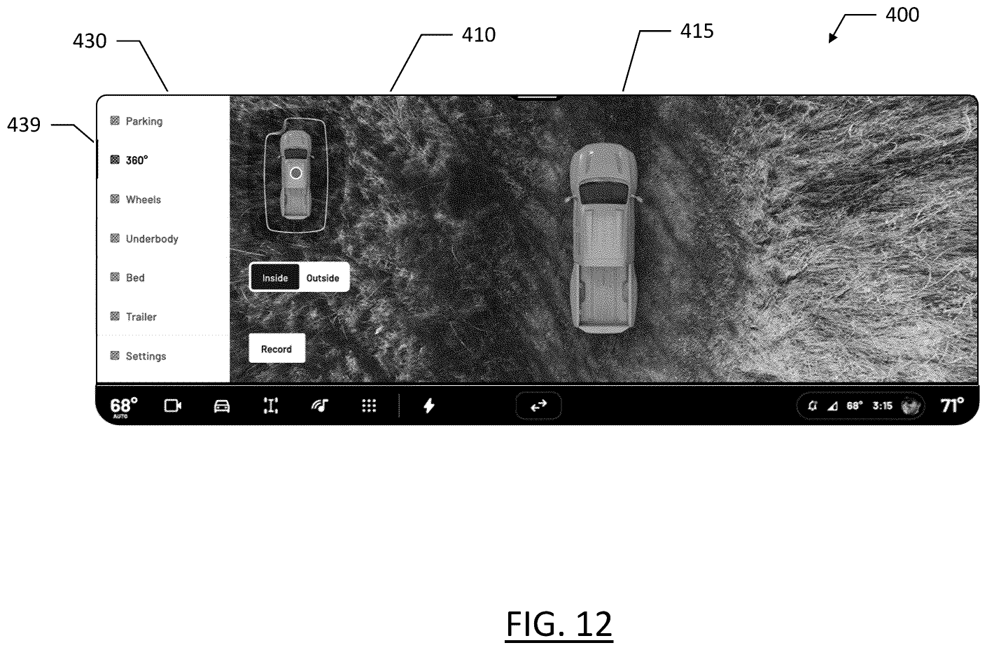

FIG. 12 illustrates an example of a graphical user interface 400 that is presenting a camera interface 410 depicting one or more camera views of an environment of the vehicle. The cameras may correspond to sensors, such as sensors embodied by or in communication with the ADAS 80 of FIG. 1 which may include image sensors of a vehicle 10 whose output can be provided for display on a graphical user interface configured according to the processor 50. According to such an embodiment, a representation 415 of the vehicle is presented in the camera interface 410 to aid an operator in orienting the various camera views to the vehicle. As illustrated, a menu interface 430 is presented on a left side of the graphical user interface 400 in an operator-centric manner as the operator may be best equipped to select a camera view when traveling at low speeds. The view shown is a 360-degree view selected by 360° interface element 439 which depicts a virtual 360-degree view formed by a plurality of cameras positioned on the vehicle and stitched together about the representation 415 of the vehicle to appear as a birds-eye view from above the vehicle.

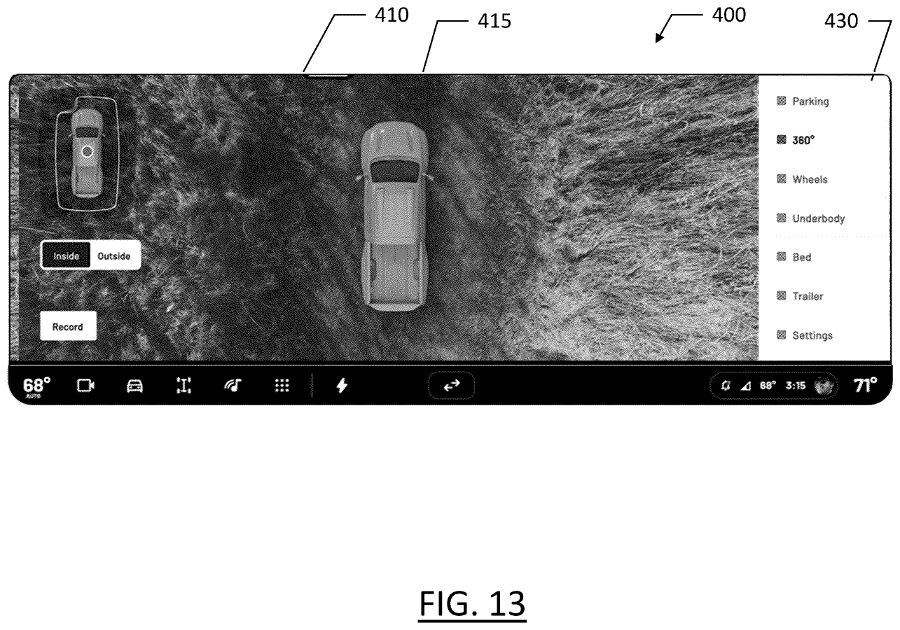

The menu interface 430 can be repositioned to a right side of the graphical user interface 400 in an instance in which camera view control is desirable to be controlled by an occupant of the vehicle. This manipulation can be performed, for example, using a “swap” button, a drag-and-drop motion, or in some embodiments a user input received on a right side of the graphical user interface 400 as there is no other interface element present on the right side such that a touch in that vicinity suggests that area is desirable for use as a user input area. It may be desirable for an occupant to control a camera view in an environment such as an offroad situation where an operator is focused on navigating by line-of-sight through the windshield and windows, while an occupant may keep an eye on a camera view of the underbody of the vehicle to look out for objects that may damage the vehicle. Further, an occupant may interface with the menu interface 430 to adjust settings, views, etc. as the vehicle is driven. FIG. 13 illustrates an example embodiment of the camera interface 410 shown while the menu interface 430 is presented on the right side of the graphical user interface 400. When the menu interface is displayed, the vehicle representation 415 may be centered within the remaining portion of the graphical user interface much as the icon in the map interfaces provided above maintains a position proximate a center of the portion of the graphical user interface on which the interface is depicted.

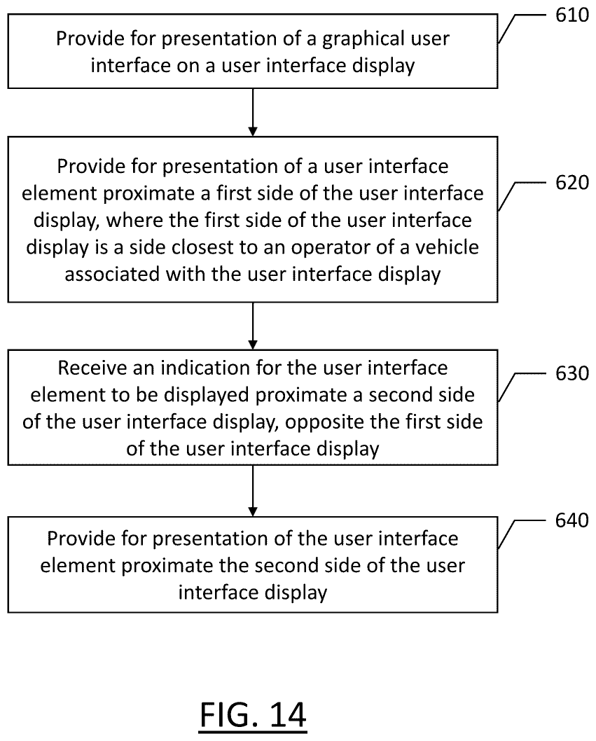

FIG. 14 is a flowchart illustrative of one or more methods according to example embodiments of the present disclosure. It will be understood that each block of the flowcharts and combination of blocks in the flowcharts may be implemented by various means, such as hardware, firmware, processor, circuitry, and/or other communication devices associated with execution of software including one or more computer program instructions. For example, one or more of the procedures described above may be embodied by computer program instructions. In this regard, the computer program instructions which embody the procedures described above may be stored by a memory 60 of an apparatus employing an embodiment of the present disclosure and executed by a processor 50 of the controller 20. As will be appreciated, any such computer program instructions may be loaded onto a computer or other programmable apparatus (for example, hardware) to produce a machine, such that the resulting computer or other programmable apparatus implements the functions specified in the flowchart blocks. These computer program instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart blocks.

Accordingly, blocks of the flowcharts support combinations of means for performing the specified functions and combinations of operations for performing the specified functions. It will also be understood that one or more blocks of the flowcharts, and combinations of blocks in the flowcharts, can be implemented by special purpose hardware-based computer systems which perform the specified functions, or combinations of special purpose hardware and computer instructions.

FIG. 14 illustrates a method of presenting a communal user experience for a user interface. At step 610, a graphical user interface is provided for presentation via a user interface display on an interior of a vehicle. For example, the user interface display device could include one or more user interface devices 70 of FIG. 1 and may be controlled by the controller 20 to present the image. The image may include, for example, a map representation of a geographical region in which the vehicle is located. A user interface element is provided for presentation proximate a first side of the user interface display at 620, where the first side of the user interface display is a side closest to an operator of a vehicle associated with the user interface display. An indication is received at 630, such as through user interface 550 of FIG. 1, which may include the display, for the user interface element to be displayed proximate a second side of the user interface display, opposite the first side of the user interface display. The indication can include, for example, an input received on the user interface display proximate the second side of the display, an indication that an occupant intends to interact with the user interface display (e.g., using a proximity sensor or image sensor). At 640, the user interface element is provided for presentation proximate the second side of the user interface display.

In an example embodiment, an apparatus for performing the methods of FIG. 14 above may include a processor (e.g., the processor 50) configured to perform some or each of the operations (610-640) described above. The processor may, for example, be configured to perform the operations (610-640) by performing hardware implemented logical functions, executing stored instructions, or executing algorithms for performing each of the operations. Alternatively, the apparatus may comprise means for performing each of the operations described above. In this regard, according to an example embodiment, examples of means for performing operations 610-640 may comprise, for example, the processor 50 and/or a device or circuit for executing instructions or executing an algorithm for processing information as described above.

Many modifications and other embodiments of the present disclosure set forth herein will come to mind to one skilled in the art to which these embodiments pertain having the benefit of the teachings presented in the foregoing descriptions and the associated drawings. Therefore, it is to be understood that the embodiments are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

That which is claimed:

1. A vehicle comprising:
a user interface display for displaying graphical user interfaces to occupants of the vehicle, wherein the user interface display is configured to:
display a graphical user interface on the user interface display;
display a user interface element proximate a first side of the user interface display, wherein the first side of the user interface display comprises a side closest to an operator of a vehicle associated with the user interface display; and
a controller in communication with the user interface display, wherein the controller is configured to:
receive an indication for the user interface element to be displayed proximate a second side of the user interface display, opposite the first side of the user interface display,
wherein the user interface display is further configured to, in response to the indication, display the user interface element proximate the second side of the user interface display.

2. The vehicle of claim 1, wherein the indication for the user interface element to be displayed proximate the second side of the user interface display comprises a user input received at the user interface display.

3. The vehicle of claim 2, wherein the user interface display configured to display the user interface element proximate the second side of the user interface display is further configured to cease to display the user interface element proximate the first side of the user interface display.

4. The vehicle of claim 1, wherein the indication for the user interface element to be displayed proximate the second side of the user interface display comprises a determination of a presence of an occupant in a seat closest to the second side of the user interface display.

5. The vehicle of claim 4, wherein the determination of the presence of the occupant in the seat closest to the second side of the user interface display comprises receiving a signal from at least one of a proximity sensor or a seat sensor identifying the presence of the occupant.

6. An apparatus comprising at least one processor and at least one non-transitory memory including computer program code instructions, the computer program code instructions configured to, when executed by the at least one processor, cause the apparatus to:
provide for presentation on a user interface display of a graphical user interface;
provide for presentation of a user interface element proximate a first side of the user interface display, wherein the first side of the user interface display comprises a side closest to an operator of a vehicle associated with the user interface display;
receive an indication for the user interface element to be displayed proximate a second side of the user interface display, opposite the first side of the user interface display; and
in response to the indication, provide for presentation of the user interface element proximate the second side of the user interface display.

7. The apparatus of claim 6, wherein the indication for the user interface element to be displayed proximate the second side of the user interface display comprises a determination of a presence of an occupant in a seat closest to the second side of the user interface display.

8. The apparatus of claim 7, wherein the determination of the presence of the occupant in the seat closest to the second side of the user interface display comprises receiving a signal from at least one of a proximity sensor or a seat sensor identifying the presence of the occupant.

9. The apparatus of claim 6, wherein the indication comprises a determination that the operator is unavailable to interact with the user interface element, wherein the determination comprises at least one of:
a determination that attention of the operator is required for safe vehicle control; or
a determination of an imminent maneuver of the vehicle requiring operator input.

10. The apparatus of claim 6, wherein the indication for the user interface element to be displayed proximate the second side of the user interface display comprises a user input received at the user interface display.

11. The apparatus of claim 10, wherein the user input received at the user interface display comprises at least one of:
an input received proximate the second side of the user interface display; or
an input received proximate the first side of the user interface display of a motion toward the second side of the user interface display.

12. The apparatus of claim 6, wherein causing the apparatus to provide for presentation of the user interface element proximate the second side of the user interface display further comprises causing the apparatus to provide for removal from presentation of the user interface element from proximate the first side of the user interface display.

13. The apparatus of claim 12, wherein causing the apparatus to provide for removal from presentation of the user interface element from proximate the first side of the user interface display comprises causing the apparatus to, through an animation on the user interface display, slide the user interface element off of the first side of the user interface display.

14. The apparatus of claim 13, wherein causing the apparatus to provide for presentation of the user interface element proximate the second side of the user interface display comprises causing the apparatus to, through an animation on the user interface display, slide the user interface element onto the second side of the user interface display.

15. The apparatus of claim 14, wherein the animation on the user interface display to slide the user interface element off the first side of the user interface display is synchronized with the animation on the user interface display to slide the user interface element onto the second side of the user interface display.

16. The apparatus of claim 15, wherein no part of the user interface element is provided for display on the user interface display at more than one location at the same time.

17. The apparatus of claim 16, wherein the graphical user interface presented on the user interface display comprises a map interface comprising an icon representing a location of the vehicle on the map interface.

18. The apparatus of claim 17, wherein causing the apparatus to provide for presentation of the user interface element proximate the second side of the user interface display comprises causing the apparatus to:
shift presentation of the map interface on the user interface display; and
retain the icon proximate a center of the map interface presented on the user interface display.

19. A method comprising:
providing for presentation on a user interface display of a graphical user interface;
providing for presentation of a user interface element proximate a first side of the user interface display, wherein the first side of the user interface display comprises a side closest to an operator of a vehicle associated with the user interface display;
receiving an indication for the user interface element to be displayed proximate a second side of the user interface display, opposite the first side of the user interface display; and
in response to the indication, providing for presentation of the user interface element proximate the second side of the user interface display.

20. The method of claim 19, wherein the indication for the user interface element to be displayed proximate the second side of the user interface display comprises a user input received at the user interface display.
